(19) United States
(12) Patent Application Publication
(10) Pub. No.: US 2009/0216879 A1
(43) Pub. Date: Aug. 27, 2009

(54) ELEMENT MANAGEMENT SYSTEM WITH FUNCTION TO TRANSFER DATABASE

(75) Inventors: Hiroyuki WARASHINA, Kawasaki (JP); Mitsuhiro Kitamura, Kawasaki (JP); Shiro Takayama, Miyazaki (JP); Keizou Hirano, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/390,411

(22) Filed: Feb. 21, 2009

(30) Foreign Application Priority Data
Feb. 22, 2008 (JP) 2008-041148

(51) Int. Cl. G06F 15/173

(52) U.S. Cl. 709/224

(57) ABSTRACT

An element management system which allows a client to monitor and control elements on a network through element management servers includes a unit configured to manage a transfer state separately for each element when management information regarding an element accommodated in a first element management server is to be transferred to a second element management server, and a unit configured to cause the management information at the second element management server to reflect a differential between the management information at the first element management server and the management information at the second element management server upon creation of the differential that is created by the client upon controlling an element for which the transfer state indicates uncompleted transfer, wherein an accommodated element is transferred in real time between the first and second element management servers without suspending monitor and control performed by the first and second element management servers.

### CROSS-REFERENCE TO RELATED APPLICATIONS

The present application is based upon and claims the benefit of priority from the prior Japanese Patent Application No. 2008-041148 filed on Feb. 22, 2008, with the Japanese Patent Office, the entire contents of which are incorporated herein by reference.

### BACKGROUND OF THE INVENTION

1. Field of the Invention

The disclosures herein relate to an element management system such as an EMS (element management system) that allows a client to monitor and control a plurality of elements on a network through a plurality of servers.

2. Description of the Related Art

Elements such as transmission elements used by communications providers need to be monitored and controlled because their troubles greatly affect the provision of services and element settings often need to be modified. To this end, an element management system such as an EMS is installed to allow maintenance personnel to monitor and control these elements in a remote fashion by use of a GUI (graphical user interface).

FIG. 1 is a drawing showing an example of the configuration of a related-art element management system. Elements 1 (1#001 through 1#n) are connected to a network 2 referred to as a DCN (data communication network). Clients 5 (5#1 through 5#m) operated by maintenance personnel are connected to a network 4 that is another DCN. An EMS server 3 situated between the network 2 and the network 4 serves to allow the maintenance personnel operating the clients 5 to monitor and control the elements 1. One or more EMS servers 3 may be provided as many as necessary by taking into account the number of the elements 1 to be monitored and controlled and also the needs associated with management tasks. Separation of the network 2 from the network 4 can prevent the clients 5 from tampering with the elements 1 without going through the EMS server 3. If there is no need for such precaution, the network 2 and the network 4 may be implemented as a single network.

Each of the elements 1 sends a report (i.e., alarm) to the EMS server 3 via the network 2 upon detecting a trouble. Upon detecting this report, the EMS server 3 uses a monitor and control unit 32 to analyze the report, and stores the results of analysis and the like in a database (DB) 33. Further, the EMS server 3 uses an interface unit 31 to notify all the clients 5 connected through the network 4 in real time. Based on the notification, each of the clients 5 displays trouble-related information on the GUI that is detected by the elements 1. In this manner, the maintenance personnel become aware of the alert in real time.

When the maintenance personnel need to modify settings of the elements 1 (e.g., register a package (PGK), register or remove path information), a control request is sent from the clients 5 to the EMS server 3. In response, the EMS server 3 exchanges commands with the elements 1 in real time to modify the settings of the elements 1. Modified settings and a confirmation as to whether settings are properly modified in the elements 1 are also reported to the clients 5 from the EMS server 3 in real time based on a command response sent from the elements 1 to the EMS server 3.

An action performed by the clients 5 to place the elements 1 in such a state that the elements 1 can be monitored and controlled via the EMS server 3 is referred to as “putting online”. Further, an action performed by the clients 5 to place the elements 1 in such a state that the elements 1 can no longer be monitored and controlled via the EMS server 3 is referred to as “taking offline”.

As previously described, two or more EMS servers 3 may be installed. When the EMS server 3 managing an element 1 changes from a given EMS server 3 to another EMS server 3, there is a need to transfer a database between the EMS servers 3.

FIGS. 2A and 2B are drawings showing an example of a situation in which a database needs to be transferred due to an addition of an element or a change of accommodation.

In FIG. 2A, a total of 480 elements 1#001 through are accommodated in an EMS server 3A. The maximum number of elements that can be accommodated in the EMS server 3A is 500 in this example. When 40 new elements 1#481 through are added, the total number exceeds the maximum number of elements that can be accommodated in the EMS server 3A. A new EMS server 3B is thus installed to accommodate the new elements 1#481 through 1#520. In this case, the old EMS server 3A already accommodates 480 elements that are close to a maximum number of 500 that can be accommodated whereas the new EMS server 3B accommodates only 40 elements that is rather a small number. There is a large difference in the numbers of accommodated elements. In such a case, the accommodated elements are required to be redistributed evenly for the purpose of avoiding unevenness in server performance. Accordingly, some of the elements accommodated in the old EMS server 3A are moved to the new EMS server 3B so that these two servers each accommodate 260 elements. To this end, a database needs to be transferred between the EMS server 3A and the EMS server 3B.

In FIG. 2B, the existing EMS server 3A accommodates elements 1#001 through 1#008, and the existing EMS server 3B accommodates elements 1#009 through 1#016. A management unit may be modified due to some user need, so that a central management system covering all of Japan may be changed to two management systems covering the east part of Japan and the west part of Japan, respectively, for example. As a result, elements having even numbers (i.e., those installed in eastern Japan) among the elements accommodated in the EMS server 3A are moved to the EMS server 3B, and elements having odd numbers (i.e., those installed in western Japan) among the elements accommodated in the EMS server 3B are moved to the EMS server 3A. In such a case, a database needs to be transferred between the EMS server 3A and the EMS server 3B.

FIG. 3 is a drawing showing an example of database transfer performed for the purpose of moving accommodated elements in a related-art element management system. An edit server 6 is used to transfer a database. Databases 33A and 33B of the EMS servers 3A and 3B include element management tables used to identify elements that are being managed. FIG. 4 is a sequence chart showing an example of processing performed to transfer a database.

In FIG. 3 and FIG. 4, the EMS server 3A accommodates elements 1#001, 1#002, and 1#003, and the EMS server 3B accommodates an element 1#004 before transfer. The element 1#002 is then moved from the EMS server 3A to the EMS server 3B.

In order to prevent the databases in the EMS servers 3A and 3B from being modified during the transfer, operation restriction is put in place to prohibit any operation that causes the element information to be updated (steps S1, S2).

Then, the contents of the databases (i.e., element management tables) of the EMS servers 3A and 3B are stored as a backup in the edit server 6 (steps S3, S4).

The contents of the backup element management tables are edited by use of the edit server 6. Namely, the element is removed from the element management table of the EMS server 3A, and is added to the element management table of the EMS server 3B (step S5).

The system operation of the EMS server 3A is temporarily suspended (step S6). The contents of the database (element management table) of the EMS server 3A is restored, followed by reactivating the EMS server 3A (step S7). After the restore and reactivation, the EMS server 3A starts monitoring and controlling the elements 1#001 and 1#002 according to the element management table as edited.

By the same token, the system operation of the EMS server 3B is temporarily suspended (step S8). The contents of the database (element management table) of the EMS server 3B is restored, followed by reactivating the EMS server 3B (step S9). After the restore and reactivation, the EMS server 3B starts monitoring and controlling the elements 1#003 and 1#004 according to the element management table as edited.

The operation restriction is lifted after confirming that the EMS servers 3A and 3B can now monitor and control the elements 1#001 through 1#004 (steps S10, S11)

In FIG. 4, both the EMS server 3A and the EMS server 3B cannot be controlled from the clients 5 due to the operation restriction during steps S1 through S11. The reason why the operation restriction is necessary is as follows. If the databases of the EMS servers 3A and 3B are updated during steps S1 through S11, differences are created between the updated databases and the backup databases obtained in steps S3 and S4. When the backup databases having such differences are restored to the EMS servers 3A and 3B, inconsistency in element settings develops between the elements 1 and the EMS servers 3A and 3B. This may render the elements 1 unable to be monitored and/or may cause the stoppage of communication line services.

Further, system reactivation is required upon restoring databases, so that the monitoring function is disabled until the reactivation is completed.

The same restrictions are imposed even when the EMS server 3A and the EMS server 3B have redundant configurations.

Japanese Patent Application Publication No. 2000-181833 discloses an online environment automatic modification system that can add and remove a terminal to be used in the system while the online system is in operation.

The related-art element management system having the configuration and operations as described above have the following problems.

In an environment in which the elements 1 being monitored and controlled provide services 24 hours a day, 365 days a year without any interruption, it is required, as a general principle, that the EMS server 3 also does not stop its monitor and control function. As previously described, however, a related-art database transfer action requires that operation restriction such as the prohibition of updating of element settings be imposed and a period of no monitoring is created until the transfer of data is completed. Such arrangement is not consistent with the need not to suspend monitor and control.

Japanese Patent Application Publication No. 2000-181833 does not address the transfer of databases, and, thus, does not offer any solution to the problems described above.

Accordingly, there is a need for an element management system that can eliminate the need for operation restriction and a period of no monitoring during the transfer of database for moving accommodated element.

### SUMMARY OF THE INVENTION

According to an embodiment, an element management system which allows a client to monitor and control a plurality of elements on a network through a plurality of element management servers includes a first unit configured to manage a transfer state separately for each element when management information regarding an element accommodated in a first element management server is to be transferred to a second element management server, and a second unit configured to cause the management information at the second element management server to reflect a differential between the management information at the first element management server and the management information at the second element management server upon creation of the differential that is created by the client upon controlling an element for which the transfer state indicates uncompleted transfer, wherein an accommodated element is transferred in real time between the first and second element management servers without suspending monitor and control performed by the first and second element management servers.

According to at least one embodiment, data indicative of an accommodated element can be moved to another server without suspending the monitoring and control of the element.

### BRIEF DESCRIPTION OF THE DRAWINGS

Other objects and further features of the present invention will be apparent from the following detailed description when read in conjunction with the accompanying drawings, in which:

FIG. 1 is a drawing showing an example of the configuration of a related-art element management system;

FIGS. 2A and 2B are drawings showing an example of a situation in which a database needs to be transferred due to an addition of an element or a change of accommodation;

FIG. 3 is a drawing showing an example of database transfer performed for the purpose of moving accommodated elements in a related-art element management system;

FIG. 4 is a drawing showing an example of database transfer performed for the purpose of moving accommodated elements in a related-art element management system;

FIG. 5 is a drawing showing an example of the configuration of an element management system;

FIGS. 6A and 6B are drawings showing an example of transitions of a DB transfer state with respect to an origin EMS server and a destination EMS server;

FIG. 7 is a drawing showing an example of database transfer between EMS servers;

FIG. 8 is a drawing showing an example of database transfer between EMS servers;

FIGS. 9A through 9E are drawings showing examples of data;

FIGS. 10A through 10E are drawings showing examples of data; and

FIGS. 11A through 11D are drawings showing examples of data.

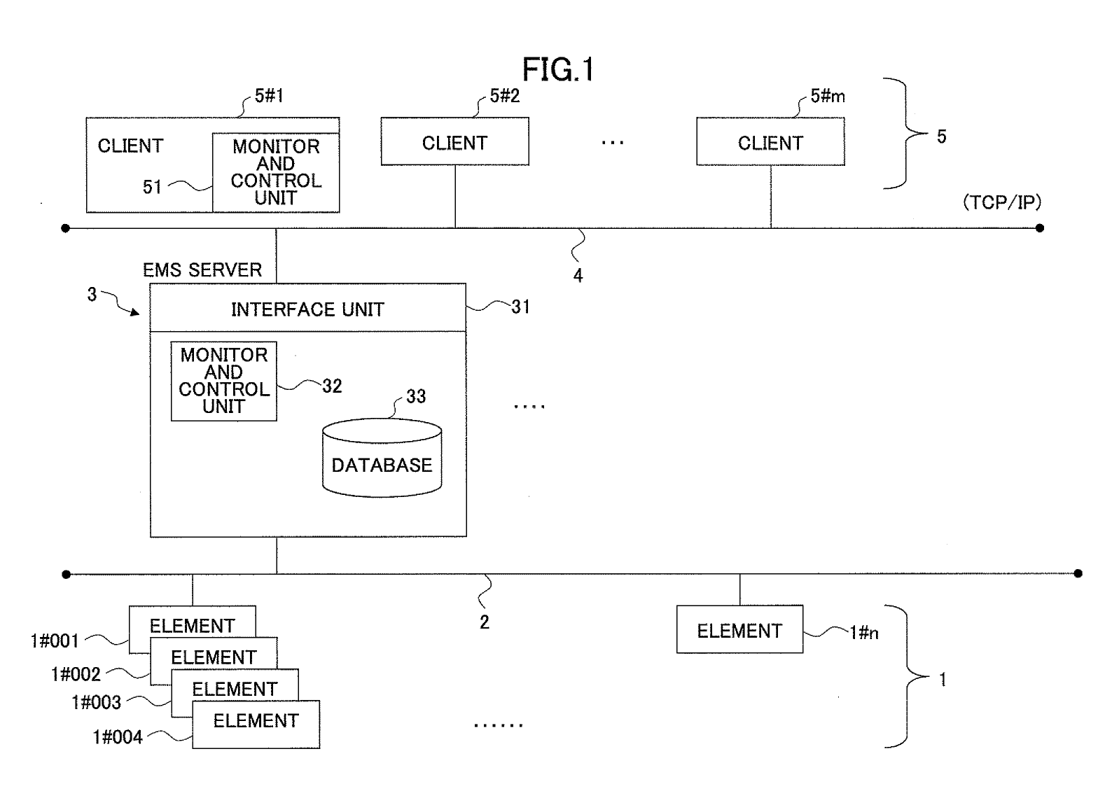

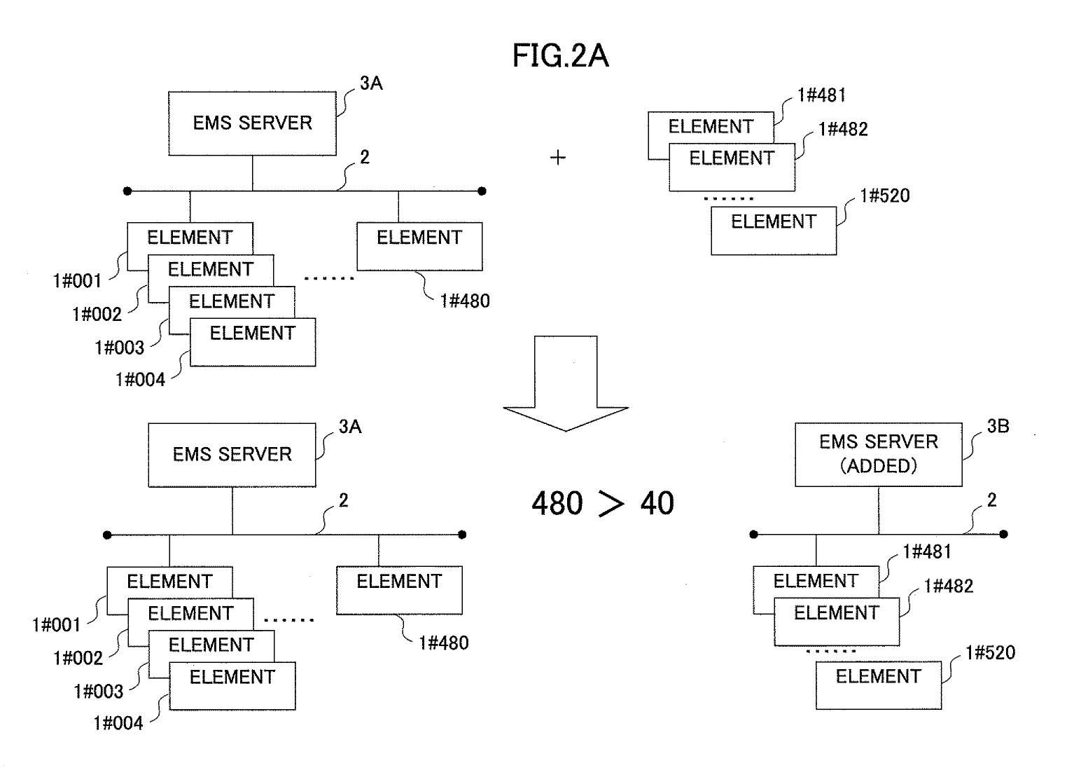

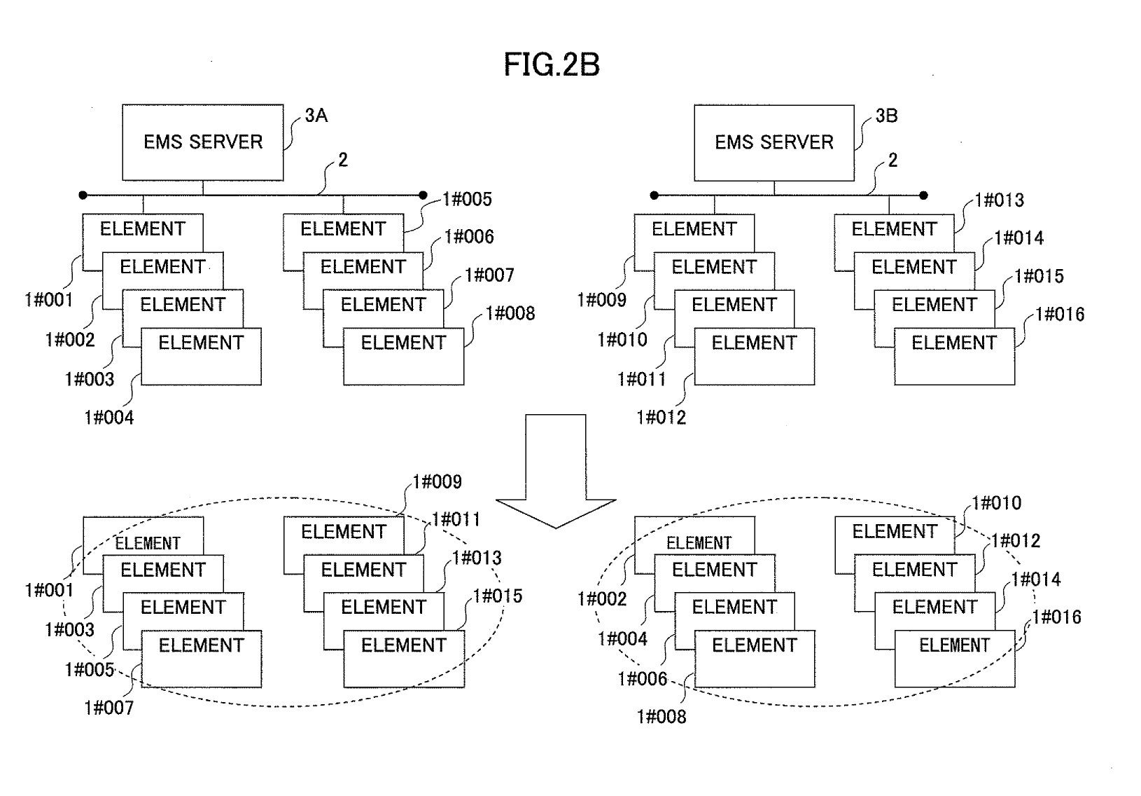

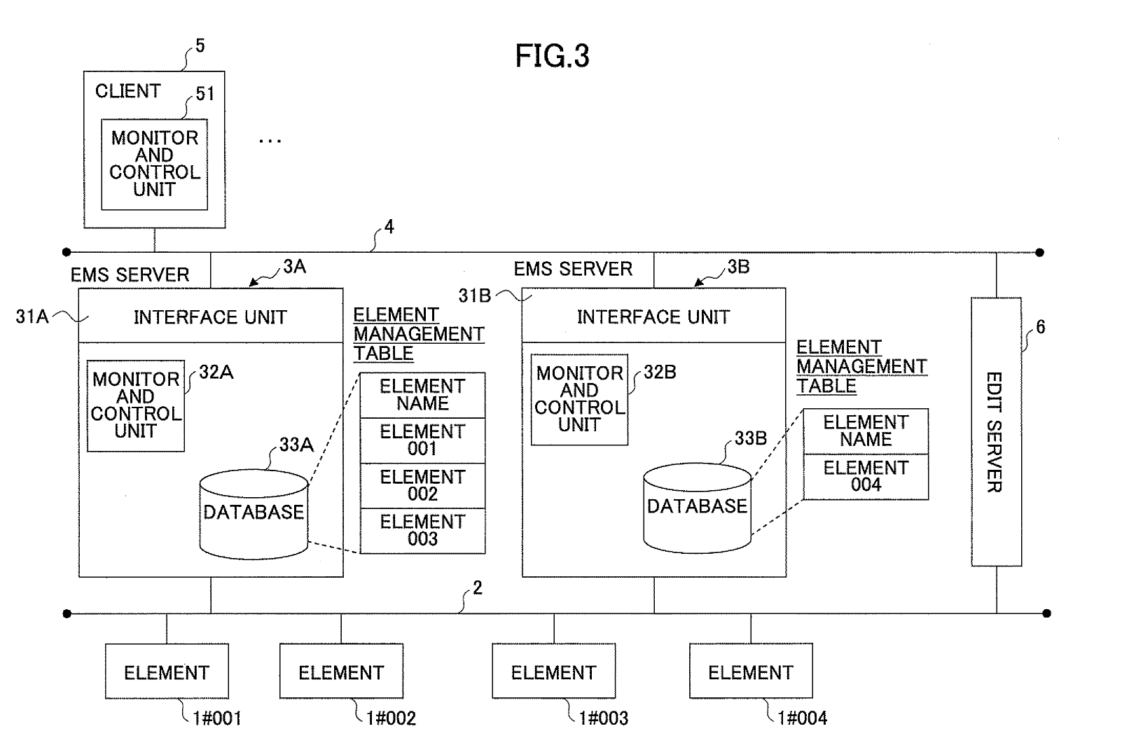

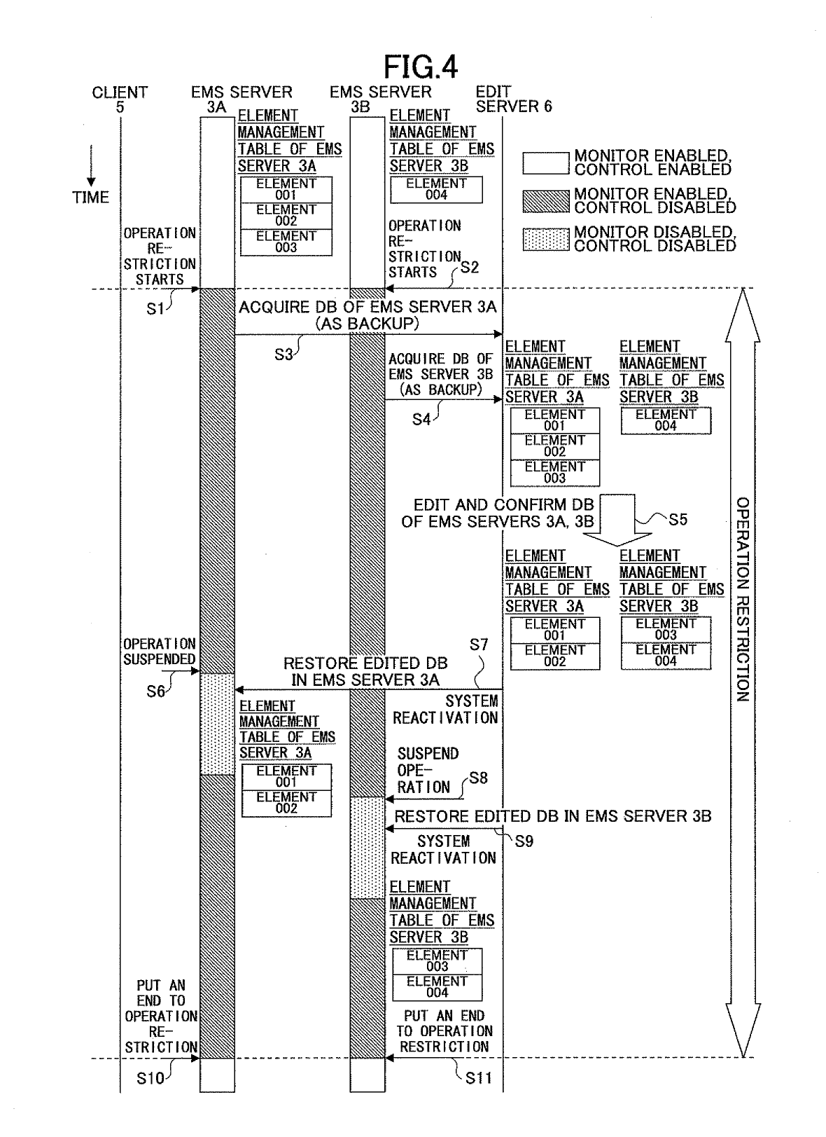

### DESCRIPTION OF THE PREFERRED EMBODIMENTS

In the following, embodiments of the present invention will be described with reference to the accompanying drawings.

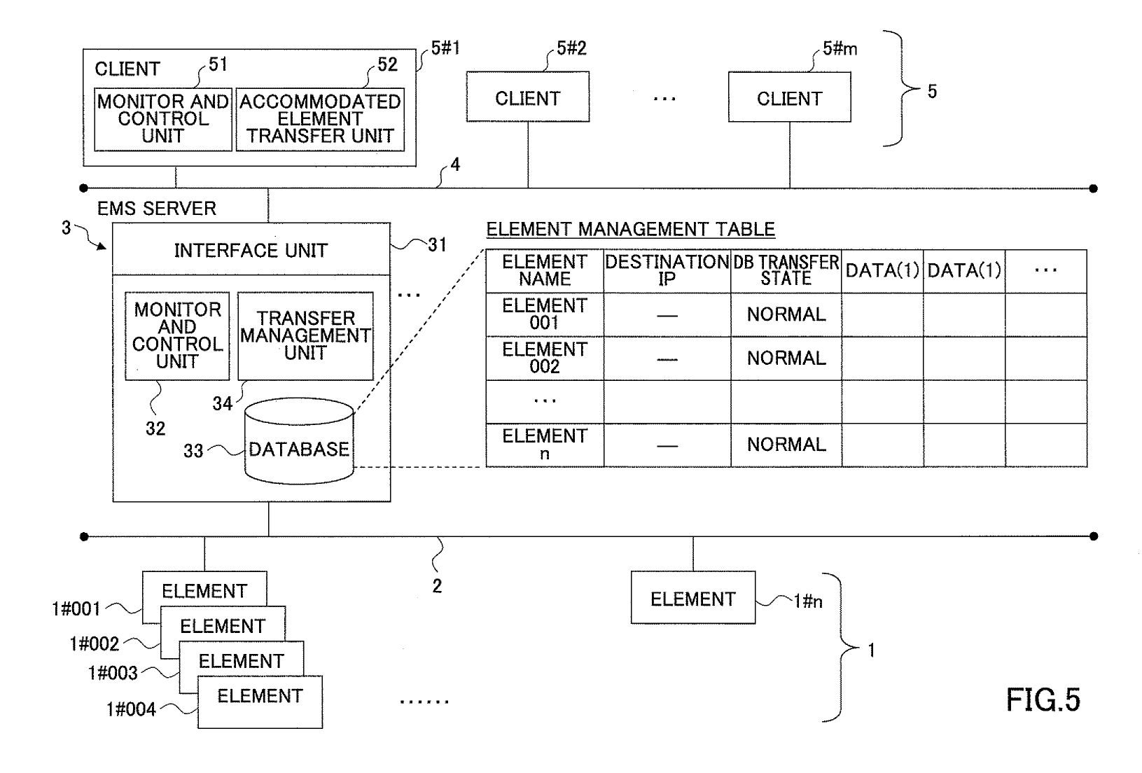

FIG. 5 is a drawing showing an example of the configuration of an element management system.

In FIG. 5, elements 1 (1#001 through 1#n) are connected to a network 2 referred to as a DCN. Clients 5 (5#1 through 5#m) operated by maintenance personnel are connected to a network 4 that is another DCN. An EMS server 3 situated between the network 2 and the network 4 serves to allow the maintenance personnel operating the clients 5 to monitor and control the elements 1. One or more EMS servers 3 may be provided as many as necessary by taking into account the number of the elements 1 to be monitored and controlled and also the needs associated with management tasks. Separation of the network 2 from the network 4 can prevent the clients 5 from tampering with the elements 1 without going through the EMS server 3. If there is no need for such precaution, the network 2 and the network 4 may be implemented as a single network.

The EMS server 3 includes an interface unit 31 for providing a GUI in response to access from the clients 5 (5#1 through 5#m), a monitor and control unit 32 for providing monitor and control functions with respect to the elements 1 (1#001 through 1#n), a database 33 for storing information regarding accommodated elements under the control thereof, and a transfer management unit 34 for providing a database transfer function. The database 33 stores an element management table for managing element information. The element management table includes an “element name” indicative of the name of an element 1 being managed, a “destination IP” indicative of the IP (Internet Protocol) address of the EMS server 3 that will accommodate the element of interest as a result of database transfer, a “DB transfer state” indicative of the state of database transfer, and various “data” such as information about settings of the element 1 of interest. The “destination IP” is set to “−” indicating the absence of information in the state in which no request for DB transfer has been received. The meaning of “DB transfer state” will be described later. After the completion of database transfer, information regarding a transferred element is removed from the element management table of the EMS server 3 serving as an origin of transfer.

Each of the clients 5 includes a monitor and control unit 51 for utilizing the functions of the monitor and control unit 32 through the interface unit 31 of the EMS server 3 to provide a user (maintenance personnel) with the function to monitor and control the elements 1 (1#001 through 1#n). Each of the clients 5 also includes an accommodated element transfer unit 52 for providing the user with the function to transfer a database regarding the elements 1 (1#001 through 1#n). The accommodated element transfer unit 52 can specify information indicative an element to be transferred and information indicative of a destination EMS server 3 that is to receive the element, and also has the function to send a DB transfer request to the destination EMS server 3.

As a basic function, each of the elements 1 sends a report (i.e., alarm) to the EMS server 3 via the network 2 upon detecting a trouble. Upon detecting the report, the EMS server 3 uses a monitor and control unit 32 to analyze the report, and stores the results of analysis and the like in a database (DB) 33. Further, the EMS server 3 uses an interface unit 31 to notify all the clients 5 connected through the network 4 in real time. Based on the notification, each of the clients 5 displays trouble-related information on the GUI that is detected by the elements 1. In this manner, the maintenance personnel become aware of the alert in real time.

When the maintenance personnel need to modify settings of the elements 1 (e.g., register a package (PGK), register or remove path information), a control request is sent from the clients 5 to the EMS server 3. In response, the EMS server 3 exchanges commands with the elements 1 in real time to modify the settings of the elements 1. Modified settings and a confirmation as to whether settings are properly modified in the elements 1 are also reported to the clients 5 from the EMS server 3 in real time based on a command response sent from the elements 1 to the EMS server 3.

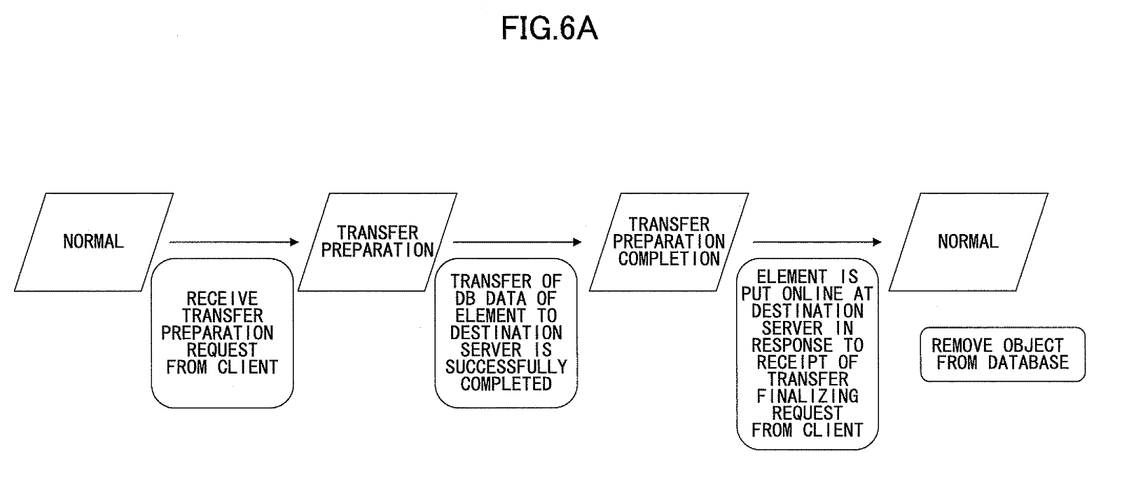

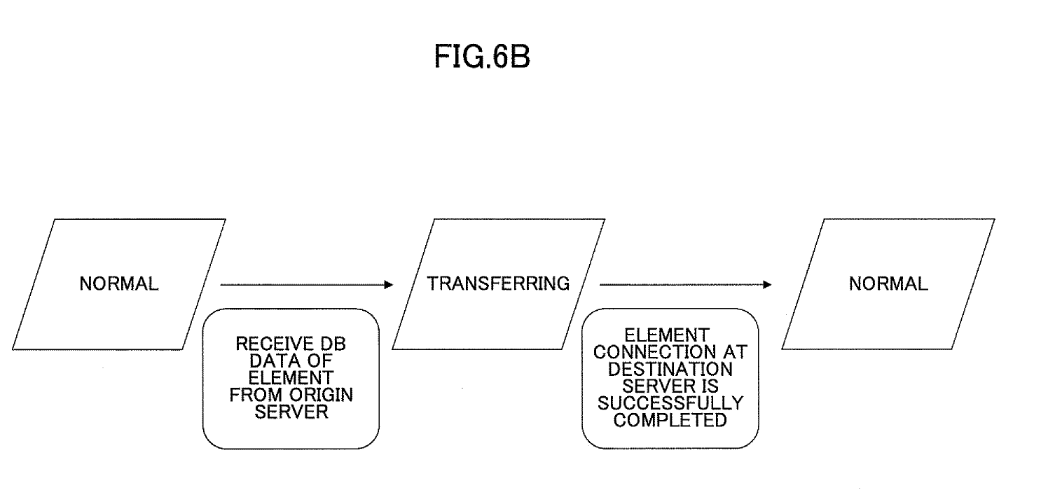

FIGS. 6A and 6B are drawings showing an example of transitions of a DB transfer state with respect to an origin EMS server 3 and a destination EMS server 3.

FIG. 6A shows the transitions of the “DB transfer state” with respect to the origin EMS server 3. As shown in FIG. 6A, there are “normal”, “transfer preparation”, and “transfer preparation completion” states. The “normal” state indicates a state in which the origin EMS server 3 has received no request for DB transfer from the clients 5. The “transfer preparation” state indicates a state in which the origin EMS server 3 has received a request for DB transfer from the clients 5. At this point in time, the transfer management unit 34 starts transferring the database contents of an element to be transferred to a specified destination EMS server 3. During this state, the data transfer process continues even when a request to control the element 1 to be transferred is made. Differential information will be transferred again without making a state transition. The “transfer preparation completion” state indicates a state in which the origin EMS server 3 has finished transferring data to the destination EMS server 3 and is waiting for approval of transfer finalization. After the approval of finalization, the destination EMS server 3 connects to the element 1 so that the destination EMS server 3 can monitor the element. The origin EMS server 3 removes the data of the transferred element from the element management table, thereby stop monitoring this element.

FIG. 6B shows the transitions of the “DB transfer state” with respect to the destination EMS server 3. As shown in FIG. 6B, there are a “normal” state and a “transferring” state. The “normal” state indicates a state in which the destination EMS server 3 has received no request for DB transfer from the clients 5, or has completed processing a request for DB transfer. The “transferring” state indicates a state in which the transfer of data from the origin EMS server 3 to the destination EMS server 3 is underway in response to a request for DB transfer received from the clients 5.

The origin and destination EMS servers 3 manage information indicative of transitions of the DB transfer state by use of the element management table. With such arrangement, management information for managing accommodated elements can be transferred on line to another EMS server 3 without performing DB backup, editing, and restoration as in the related-art configuration.

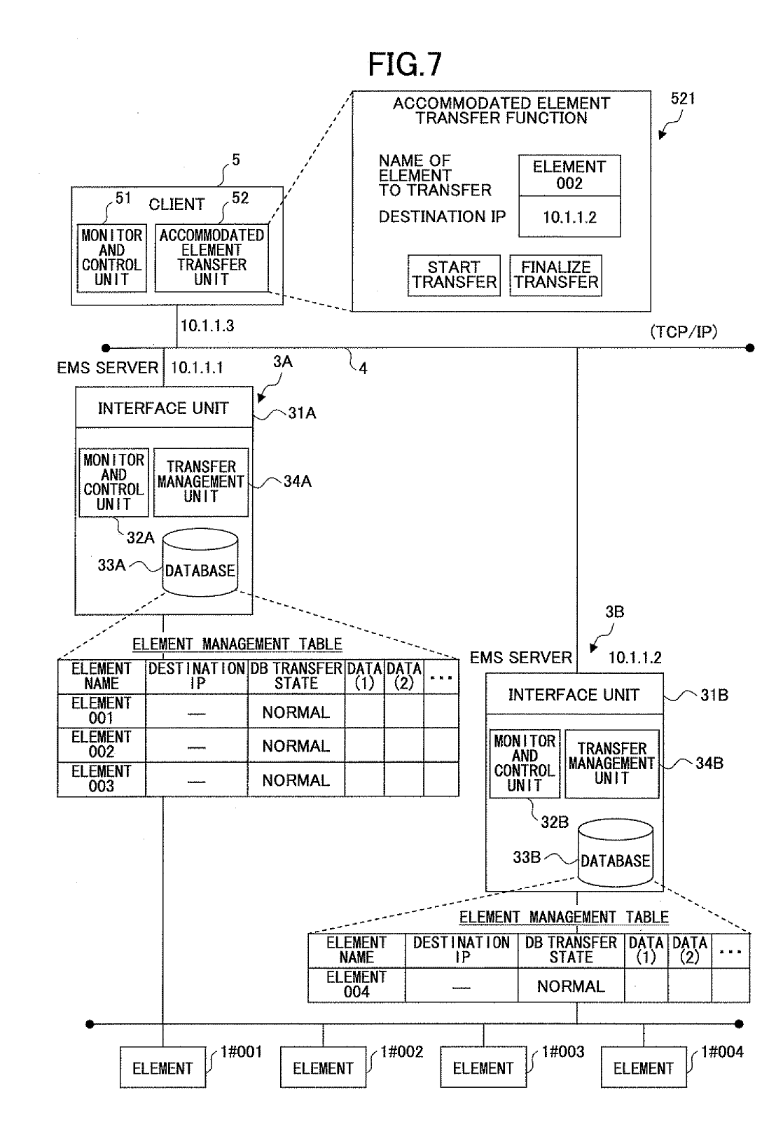

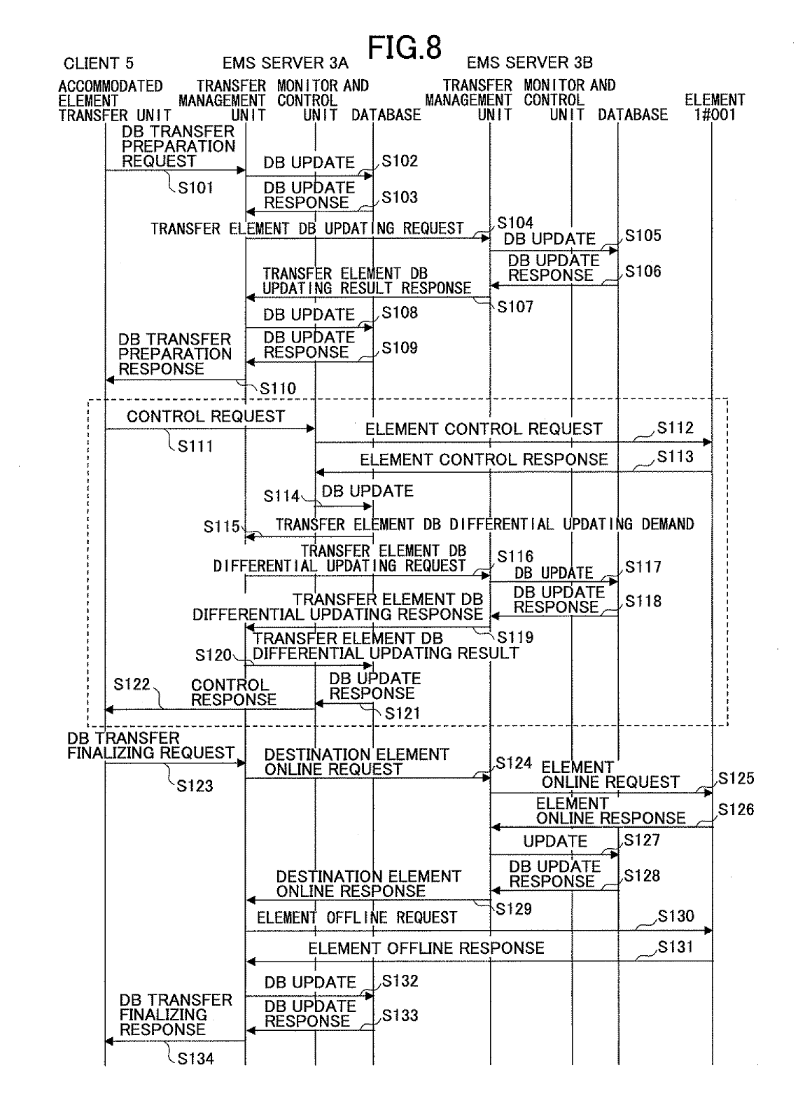

FIG. 7 is a drawing showing an example of database transfer between the EMS server 3A and the EMS server 3B. FIG. 8 is a sequence chart showing an example of a database transfer process. In FIG. 7 and FIG. 8, the EMS server 3A accommodates the elements 1#001 through 1#003, and the EMS server 3B accommodates the element 1#004. The element 1#002 that is currently managed by the EMS server 3A is then moved to the EMS server 3B.

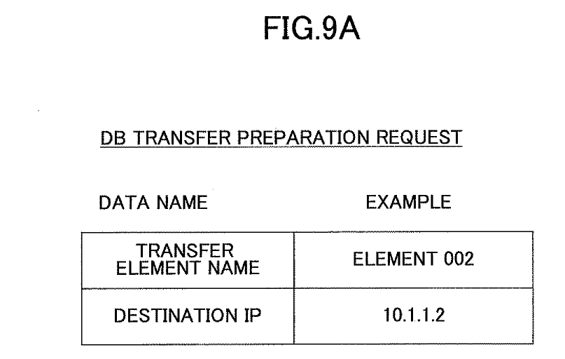

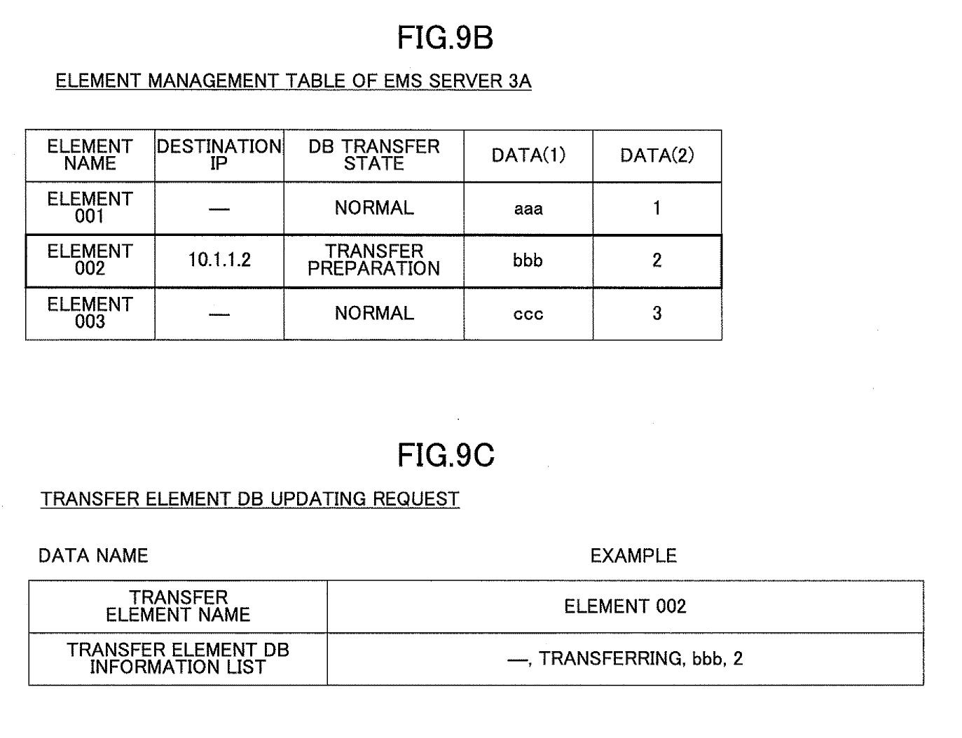

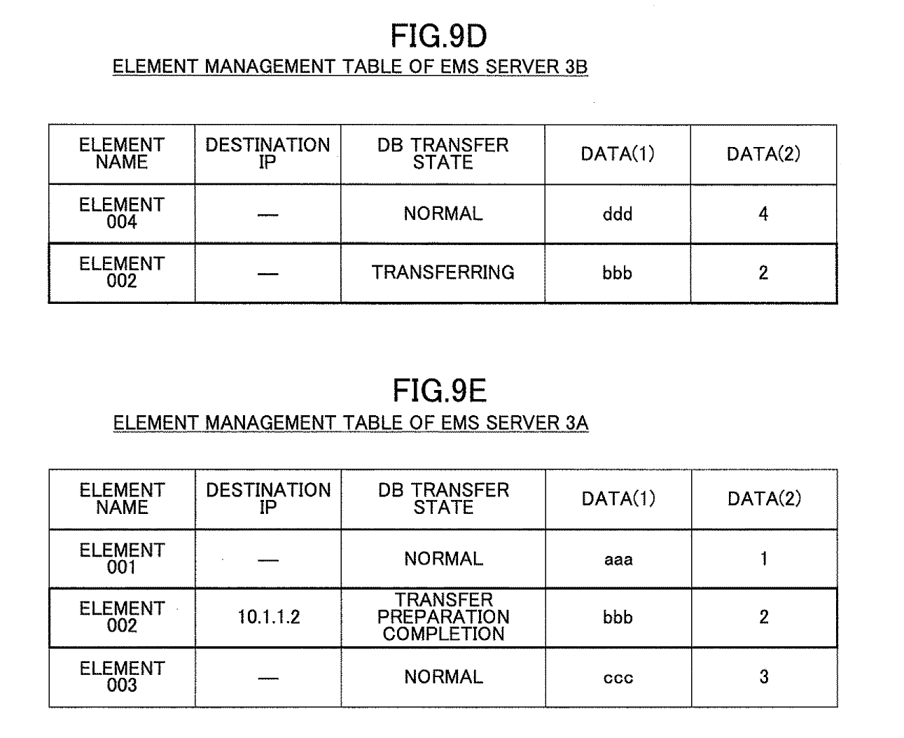

In FIG. 7 and FIG. 8, a user uses the accommodated element transfer unit 52 of a client 5 connected to the EMS server 3A to specify, on an accommodated element transfer GUI screen 521, a transfer element name “element 002” corresponding to the element 1#002 accommodated in the EMS server 3A and an IP address (destination IP) “10.1.1.2” of the destination EMS server 3B. When the user presses the “transfer start” button, the accommodated element transfer unit 52 of the client 5 sends a request for DB transfer preparation to a transfer management unit 34A of the EMS server 3A. This request includes the transfer element name “element 002” and the destination IP “10.1.1.2” specified by the user. These actions correspond to step S101. FIG. 9A is a drawing showing an example of the data structure of a DB transfer preparation request.

The transfer management unit 34A of the EMS server 3A having received the DB transfer preparation request changes the DB transfer condition from “normal” to “transfer preparation” and the destination IP from “−” to “10.1.1.2” with respect to the element name “element 002” in the element management table of the database 33A (step S102). Such changes are made by referring to the transfer element name and destination IP contained in the DB transfer preparation request. The transfer management unit 34A then receives a DB update response upon successful completion of the process (step S103). FIG. 9B is a drawing showing the state of the updated element management table of the EMS server 3A.

The transfer management unit 34A of the EMS server 3A transmits a transfer element DB updating request to a transfer management unit 34B of the EMS server 3B having the IP address “10.1.1.2” (step S104). This request contains a DB information list regarding the transfer element having the element name “element 002” in which the DB transfer condition is set to “transferring” and the destination IP set to “−”. FIG. 9C is a drawing showing an example of the data structure of a transfer element DB updating request.

The transfer management unit 34B of the EMS server 3B having received the transfer element DB updating request updates the element management table in the database 33B in response to the transfer element DB information list of the transfer element name “element 002” attached to the transfer element DB updating request (S105). The transfer management unit 34B then receives a DB update response upon successful completion (step S106). FIG. 9D is a drawing showing the state of the updated element management table of the EMS server 3B. During this state (i.e., the DB transfer state being set to “transferring”), the client 5 connected to the EMS server 3B does not display the element name “element 002”.

The transfer management unit 34B of the EMS server 3B transmits a transfer element DB updating result response to the transfer management unit 34A of the EMS server 3A (step S107).

The transfer management unit 34A of the EMS server 3A having received the transfer element DB updating result response updates the DB transfer state of the element name “element 002” from “transfer preparation” to “transfer preparation completion” (step S108). The transfer management unit 34A receives a DB update response upon successful completion (step S109). FIG. 9E is a drawing showing the state of the updated element management table of the EMS server 3A.

The transfer management unit 34A of the EMS server 3A transmits a DB transfer preparation response to the accommodated element transfer unit 52 of the client 5 (step S110). The accommodated element transfer unit 52 of the client 5 having received the DB transfer preparation response displays a message indicative of the completion of transfer preparation with respect to the element name “element 002”. For example, a “transfer finalize” button on the accommodated element transfer GUI screen 521 may be displayed as being active.

A procedure performed for changing data(1) of the element name “element 002” from “bbb” to “ddd” during the transfer of the element name “element 002” is shown in a dotted-line box in FIG. 8.

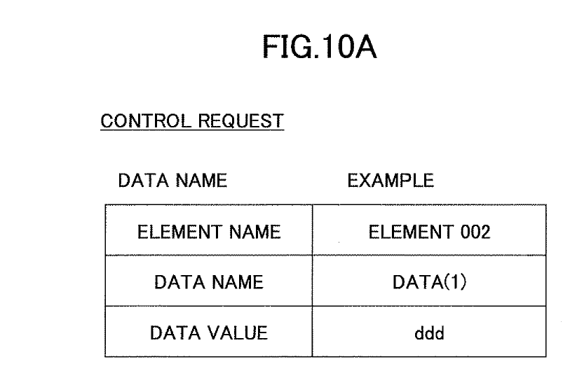

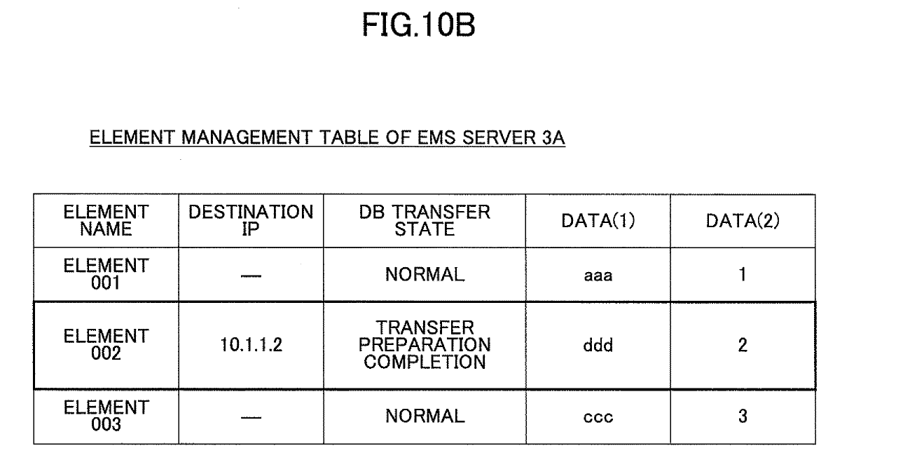

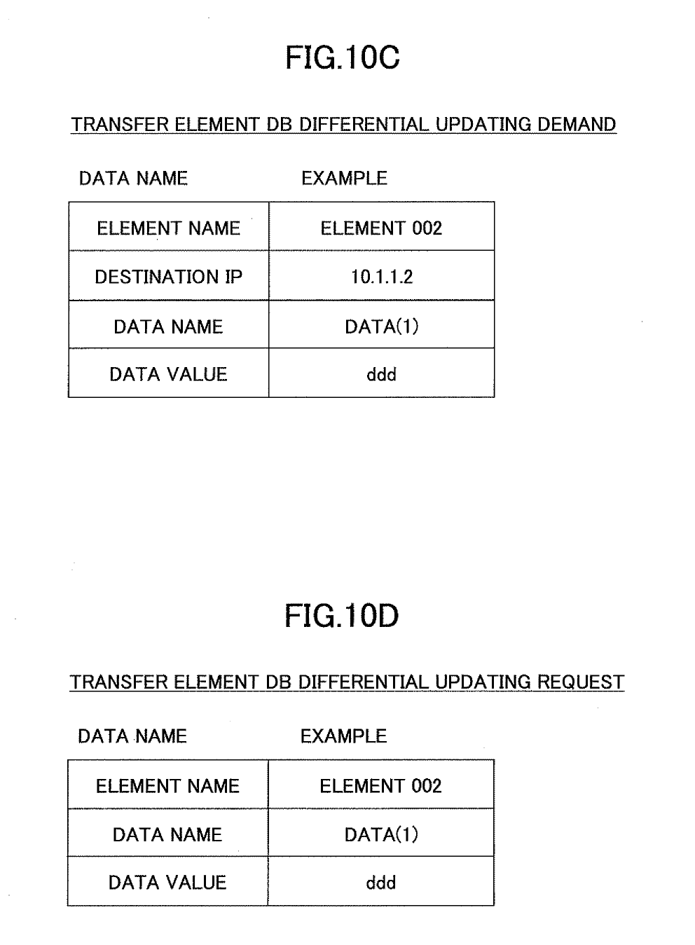

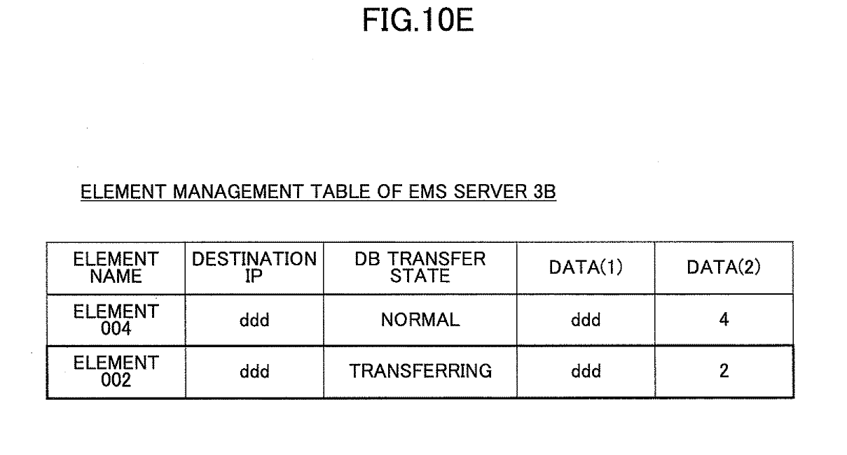

The monitor and control unit 51 of the client 5 connected to the EMS server 3A transmits a control request together with the element name “element 002” and data(1) “ddd” to the monitor and control unit 32A of the EMS server 3A (step S111). FIG. 10A is a drawing showing an example of the data structure of the control request.

The transfer management unit 34A of the EMS server 3A having received the control request identifies a target element in response to the element name “element 002” attached to the control request, and transmits an element control request to change data(1) from “bbb” to “ddd” to the element 1#002 (step S112). The transfer management unit 34A receives an element control response upon successful completion (step S113).

The transfer management unit 34A of the EMS server 3A updates the database by changing data(1) of the element name “element 002” from “bbb” to “ddd” (step S114). The database 33A of the EMS server 3A having received a database update request changes data(1) of the element name “element 002” from “bbb” to “ddd”. FIG. 10B is a drawing showing the state of the updated element management table of the EMS server 3A.

If the DB transfer state of the element name “element 002” is either “transfer preparation” or “transfer preparation completion”, the database 33A of the EMS server 3A transmits to the transfer management unit 34A of the EMS server 3A a transfer element DB differential updating demand together with the element name “element 002” and differential information indicative of a change of data(1) to “ddd” (step S115). FIG. 10C is a drawing showing an example of the data structure of a transfer element DB differential updating demand.

The transfer management unit 34A of the EMS server 3A having received the transfer element DB differential updating demand transmits a transfer element DB differential updating request to the transfer management unit 34B of the EMS server 3B identified by the IP address “10.1.1.2” attached to the transfer element DB differential updating demand (step S116). This request contains the element name “element 002” and the differential information. FIG. 10D is a drawing showing an example of the data structure of a transfer element DB differential updating request.

The transfer management unit 34B of the EMS server 3B having received the transfer element DB differential updating request updates the database based on the element name “element 002” and the differential information attached to the transfer element DB differential updating request (step S117). The transfer management unit 34B receives a DB update response upon successful completion (step S118). FIG. 10E is a drawing showing the state of the updated element management table of the EMS server 3B.

The transfer management unit 34B of the EMS server 3B transmits a transfer element DB differential updating response to the transfer management unit 34A of the EMS server 3A (step S119).

In response to the transfer element DB differential updating response, the transfer management unit 34A of the EMS server 3A transmits a transfer element DB differential updating result to the database 33A of the EMS server 3A (step S120).

Having received the transfer element DB differential updating result, the database 33A of the EMS server 3A transmits a DB updating response to the monitor and control unit 32A of the EMS server 3A (step S121).

In response to the DB updating response, the monitor and control unit 32A of the EMS server 3A transmits a control response to the monitor and control unit 51 of the client 5 (step S122). In response to the control response, the client 5 displays control results.

A description will be given of a procedure that is performed to finalize transfer regardless of whether to change data(1) of the element name “element 002” during the transfer of the element name “element 002”.

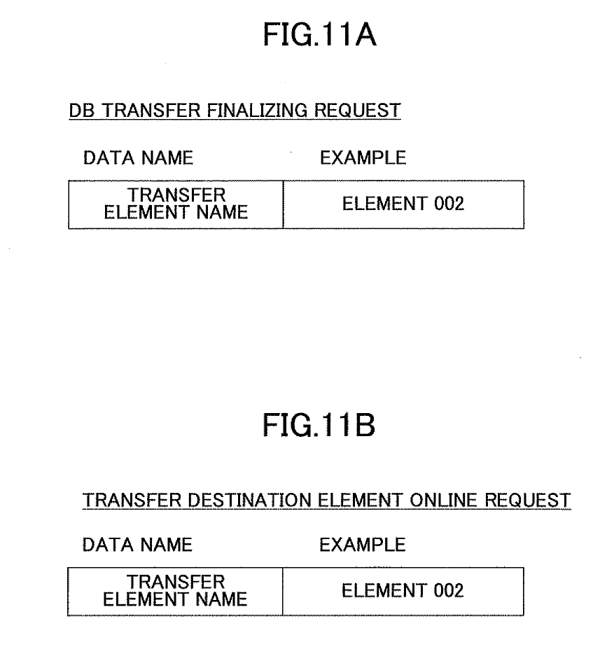

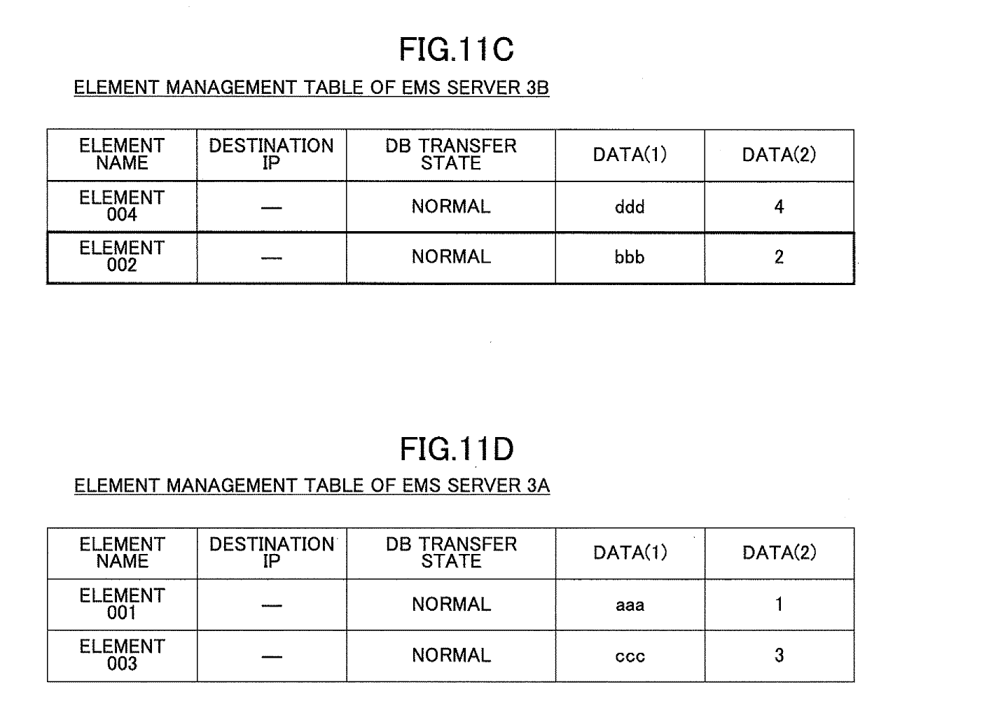

When the user presses the “transfer finalize” button on the accommodated element transfer GUI screen 521, the accommodated element transfer unit 52 of the client 5 transmits a DB transfer finalizing request together with the transfer element name “element 002” to the transfer management unit 34A of the EMS server 3A (step S123). FIG. 11A is a drawing showing an example of the data structure of a DB transfer finalizing request.

The transfer management unit 34A of the EMS server 3A having received the DB transfer finalizing request acquires the destination IP address “10.1.1.2” (i.e., EMS server 3B) from the database 33A in response to the transfer element name “element 002” attached to the DB transfer finalizing request, and transmits a destination element online request together with the transfer element name “element 002” to the transfer management unit 34B of the EMS server 3B identified by the IP address “10.1.1.2” (step S124). FIG. 11B is a drawing showing an example of the data structure of a destination element online request.

The transfer management unit 34B of the EMS server 3B having received the destination element online request acquires connection information (contained in the DB information list of the transfer element) regarding the element name “element 002” stored in the database 33B based on the transfer element name “002” attached to the destination element online request, and transmits an element online request to the element 1#002 (step S125), thereby putting the element 1#002 online. The transfer management unit 34B receives an element online response upon successful completion of the process (step S126).

The transfer management unit 34B of the EMS server 3B updates the DB transfer state of the element name “element 002” to “normal” (step S127). The transfer management unit 34B receives an update response upon successful completion of the process (step S128). FIG. 11C is a drawing showing the state of the updated element management table of the EMS server 3B.

Due to the fact that the DB transfer state of the element name “element 002” of the EMS server 3B is changed to “normal”, it becomes possible for the EMS server 3B to treat the element 1#002 as an object to be monitored, thereby allowing the client 5 to control and monitor the element 1#002 via the EMS server 3B.

In response to the DB updating response, the transfer management unit 34B of the EMS server 3B transmits a destination element online response to the EMS server 3A (step S129).

Having received the destination element online response, the transfer management unit 34A of the EMS server 3A transmits an element offline request to the element 1#002 (step S130), thereby taking the element 1#002 offline. The transfer management unit 34A receives an element offline response upon successful completion of the process (step S131).

The transfer management unit 34A of the EMS server 3A having received the element offline response updates the database by removing the data of the element name “element 002” from the element management table of the database 33A (step S132). The transfer management unit 34A receives a DB update response upon successful completion (step S133). FIG. 11D is a drawing showing the state of the updated element management table of the EMS server 3A.

Due to the fact that the data of the element name “element 002” is removed from the element management table in the database 33A of the EMS server 3A, the EMS server 3A treats the element 1#002 as an object not to be monitored. It is thus not possible for the client 5 to control and monitor the element 1#002 via the EMS server 3A.

In response to the DB update response, the transfer management unit 34A of the EMS server 3A transmits a DB transfer finalizing response to the accommodated element transfer unit 52 of the client 5 (step S134). The accommodated element transfer unit 52 of the client 5 having received the DB transfer finalizing response displays a message indicative of transfer of the element name “element 002” to the IP address “10.1.1.2”.

As described above, the element management system includes one or more EMS servers having the function to monitor and control a plurality of elements and the function to keep element setting information and alert information in database, and also includes one or more clients connectable to one or more EMS servers to provide GUI. When there is a need to transfer a database to transfer accommodated elements in such a system, element data can be transferred to a destination EMS server without requiring the destination EMS server to suspend monitoring and control with respect to its accommodated elements.

Embodiments of the present invention have been described heretofore for the purpose of illustration. The present invention is not limited to these embodiments, but various variations and modifications may be made without departing from the scope of the present invention. The present invention should not be interpreted as being limited to the embodiments that are described in the specification and illustrated in the drawings.

What is claimed is:

1. An element management system which allows a client to monitor and control a plurality of elements on a network through a plurality of element management servers, comprising:
a first unit configured to manage a transfer state separately for each element when management information regarding an element accommodated in a first element management server is to be transferred to a second element management server; and
a second unit configured to cause the management information at the second element management server to reflect a differential between the management information at the first element management server and the management information at the second element management server upon creation of the differential that is created by the client upon controlling an element for which the transfer state indicates uncompleted transfer,
wherein an accommodated element is transferred in real time between the first and second element management servers without suspending monitor and control performed by the first and second element management servers.

2. The element management system as claimed in claim 1, comprising:
a unit configured to update the transfer state of a given element to be transferred in the first element management server to a transfer preparation state, to transmit the management information regarding the given element together with the transfer state indicating a transferring state from the first element management server to the second element management server, and to update the transfer state of the given element in the first element management server to a transfer preparation completion state;
a unit configured to transmit differential information from the first element management server to the second element management server when the client performs control with respect to an element having the transfer state thereof being the transfer preparation state or the transfer preparation completion state and accommodated in the first element management server, thereby causing the management information at the second element management server to reflect the differential;
a unit configured to put a transferred element online at the second element management server and to update the transfer state of the transferred element to a normal state at the second element management server; and
a unit configured to take the transferred element offline at the first element management server and to remove the management information regarding the transferred element at the first element management server.

3. The element management system as claimed in claim 1, wherein the client specifies an element to be transferred and an address of the second element management server when the management information regarding an element accommodated in the first element management server is to be transferred to the second element management server.

4. An element management server in an element management system which allows a client to monitor and control a plurality of elements on a network through a plurality of element management servers, comprising:
a first unit configured to manage a transfer state separately for each element when management information regarding an element accommodated in the element management server serving as a first element management server is to be transferred to a second element management server; and
a second unit configured to cause the management information at the second element management server to reflect a differential between the management information at the first element management server and the management information at the second element management server upon creation of the differential, which is created by the client upon controlling an element for which the transfer state indicates uncompleted transfer,
wherein an accommodated element is transferred in real time between the first and second element management servers without suspending monitor and control performed by the first and second element management servers.

5. The element management server as claimed in claim 4, comprising:
a unit configured to update the transfer state of a given element to be transferred in the first element management server to a transfer preparation state, to transmit the management information regarding the given element together with the transfer state indicating a transferring state to the second element management server, and to update the transfer state of the given element in the first element management server to a transfer preparation completion state;
a unit configured to transmit differential information to the second element management server when the client performs control with respect to an element having the transfer state thereof being the transfer preparation state or the transfer preparation completion state and accommodated in the first element management server, thereby causing the management information at the second element management server to reflect the differential;
a unit configured to put a transferred element online at the second element management server and to update the transfer state of the transferred element to a normal state at the second element management server; and
a unit configured to take the transferred element offline at the first element management server and to remove the management information regarding the transferred element at the first element management server.

6. The element management server as claimed in claim 4, wherein the client specifies an element to be transferred and an address of the second element management server when the management information regarding an element accommodated in the first element management server is to be transferred to the second element management server.

7. An element management method which allows a client to monitor and control a plurality of elements on a network through a plurality of element management servers, comprising:
managing a transfer state separately for each element when management information regarding an element accommodated in a first element management server is to be transferred to a second element management server; and
causing the management information at the second element management server to reflect a differential between the management information at the first element management server and the management information at the second element management server upon creation of the differential, which is created by the client upon controlling an element for which the transfer state indicates uncompleted transfer,
wherein an accommodated element is transferred in real time between the first and second element management servers without suspending monitor and control performed by the first and second element management servers.

8. The element management method as claimed in claim 7, comprising:
updating the transfer state of a given element to be transferred in the first element management server to a transfer preparation state, transmitting the management information regarding the given element together with the transfer state indicating a transferring state from the first element management server to the second element management server, and updating the transfer state of the given element in the first element management server to a transfer preparation completion state;
transmitting differential information from the first element management server to the second element management server when the client performs control with respect to an element having the transfer state thereof being the transfer preparation state or the transfer preparation completion state and accommodated in the first element management server, thereby causing the management information at the second element management server to reflect the differential;
putting a transferred element online at the second element management server and updating the transfer state of the transferred element to a normal state at the second element management server; and
taking the transferred element offline at the first element management server and removing the management information regarding the transferred element at the first element management server.

9. The element management method as claimed in claim 7, wherein the client specifies an element to be transferred and an address of the second element management server when the management information regarding an element accommodated in the first element management server is to be transferred to the second element management server.

10. A machine-readable recording medium having a program embodied therein for causing a computer to allow a client to monitor and control a plurality of elements on a network through a plurality of element management servers, said program causing a computer serving as an element management server to provide functions of:
a first unit configured to manage a transfer state separately for each element when management information regarding an element accommodated in a first element management server is to be transferred to a second element management server; and
a second unit configured to cause the management information at the second element management server to reflect a differential between the management information at the first element management server and the management information at the second element management server upon creation of the differential, which is created by the client upon controlling an element for which the transfer state indicates uncompleted transfer,
wherein an accommodated element is transferred in real time between the first and second element management servers without suspending monitor and control performed by the first and second element management servers.

11. The machine-readable recording medium as claimed in claim 10, wherein the program causes the computer serving as the element management server to provide functions of:
a unit configured to update the transfer state of a given element to be transferred in the first element management server to a transfer preparation state, to transmit the management information regarding the given element together with the transfer state indicating a transferring state from the first element management server to the second element management server, and to update the transfer state of the given element in the first element management server to a transfer preparation completion state;
a unit configured to transmit differential information from the first element management server to the second element management server when the client performs control with respect to an element having the transfer state thereof being the transfer preparation state or the transfer preparation completion state and accommodated in the first element management server, thereby causing the management information at the second element management server to reflect the differential;
a unit configured to put a transferred element online at the second element management server and to update the transfer state of the transferred element to a normal state at the second element management server; and
a unit configured to take the transferred element offline at the first element management server and to remove the management information regarding the transferred element at the first element management server.

12. The machine-readable recording medium as claimed in claim 10, wherein the client specifies an element to be transferred and an address of the second element management server when the management information regarding an element accommodated in the first element management server is to be transferred to the second element management server.
